(19) United States
(12) Patent Application Publication
(10) Pub. No.: US 2011/0132003 A1
(43) Pub. Date: Jun. 9, 2011

(54) CONVERSION OF LIQUEFIED NATURAL GAS

(76) Inventors: Josef Pozivil, Allschwil (CH); Mathias Ragot, Sierentz (FR)

(21) Appl. No.: 13/003,896

(22) PCT Filed: Jul. 15, 2009
(86) PCT No.: PCT/IB2009/006682

§ 371 Date: Feb. 3, 2011

(30) Foreign Application Priority Data
Jul. 15, 2008 (EP) EP08352015
Oct. 24, 2008 (EP) EP08352024

(51) Int. Cl. F17C 7/00

(52) U.S. Cl. 62/45.1

(57) ABSTRACT

A method of and apparatus for converting liquefied natural gas (LNG) to a superheated fluid through vaporisation and superheating of the LNG employs a first main heat exchanger in series with a second main heat exchanger. The first main heat exchanger is heated by a condensing first heat exchange fluid flowing in a first heat exchange circuit including a first supplementary heat exchanger for revaporising the first heat exchange fluid and the second main heat exchanger by a condensing second heat exchange fluid flowing in a second heat exchange circuit including a second heat exchanger for vaporising the second heat exchange fluid. The circuits and may share a common vessel for collecting condensate. The condensing pressure of the heat exchange fluid in the first circuit is less than condensing pressure of the heat exchange fluid in the second circuit.

The present invention relates to a method and apparatus for converting liquefied natural gas to a superheated fluid. The method and apparatus are particularly suited for use on board a ship or other ocean-going vessel, for example, an FSRU (Floating Storage and Regasification Unit).

Natural gas is conveniently stored and transported in liquid state. It is generally used, however, in gaseous state. There is therefore a need to convert large volumes of liquefied natural gas to a superheated fluid, typically a gas below the critical pressure of natural gas, but sometimes a fluid at a pressure above the critical pressure.

U.S. Pat. No. 6,945,049 discloses a method and apparatus for vaporising liquefied natural gas. Liquefied natural gas is pumped through a first heat exchanger to effect vaporisation and a second heat exchanger to raise the temperature of the vapour to approximately ambient temperature, or a little below ambient temperature. The first heat exchanger is heated by a heat exchange fluid, such as propane, flowing in a closed cycle. The propane changes from gaseous to liquid state in the first heat exchanger and is converted to a gas again in a plurality of heat exchangers which are typically heated by a flow of sea water. In the second heat exchanger, the vaporised natural gas is further heated by a flow of steam.

The method and apparatus according to the invention aim at reducing the surface area of corresponding heat exchangers without undue loss of thermodynamic efficiency.

According to the present invention there is provided a method of converting liquefied natural gas to a superheated fluid, comprising the steps of:
a. passing a flow of the natural gas under pressure through a first main heat exchanger and a second main heat exchanger in series with one another;
b. heating the flow of the natural gas in the first main heat exchanger by heat exchange with a first heat exchange fluid flowing in a first endless circuit at a first pressure, the first heat exchange fluid undergoing a change of state from vapour to liquid in said first main heat exchanger;
c. further heating the flow of the natural gas in the second main heat exchanger by heat exchange with a second heat exchange fluid flowing in a second endless circuit at a second pressure, the second heat exchange fluid being of the same composition as the first heat exchange fluid and undergoing a change of state from vapour to liquid in said second main heat exchanger;
d. collecting liquid first heat exchange fluid from the first main heat exchanger and liquid second heat exchange fluid from the second main heat exchanger;
e. re-vaporising in the first endless heat exchange fluid circuit a flow of the liquefied first heat exchange fluid in a first supplementary heat exchanger and supplying the resulting vapour as the first heat exchange fluid to the first main heat exchanger;
f. re-vaporising a flow of the second liquid heat exchange fluid in a second supplementary heat exchanger in the second endless heat exchange circuit and supplying the resulting vapour as the second heat exchange fluid to the second main heat exchanger; and wherein
g. the condensing pressure of the first heat exchange fluid in the first main heat exchanger is less than the condensing pressure of the second heat exchange fluid in the second main heat exchanger.

In some preferred examples, the said resulting vapour in step (e) may be turbo-expanded intermediate the first supplementary heat exchanger and the first main heat exchanger. The turbo-expansion makes possible power recovery from the vapour.

The invention also provides apparatus for converting liquefied natural gas to a superheated fluid comprising:
a. a first main heat exchanger and a second main heat exchanger in series with one another arranged for the heating of the liquefied natural gas in heat exchange with a condensing first heat exchange fluid and a condensing second heat exchange fluid, respectively;
b. a first endless lower condensing pressure heat exchange fluid circuit extending through the first main heat exchanger;
c. a second endless higher condensing pressure heat exchange fluid circuit extending through the second main heat exchanger, wherein
d. the first and second endless heat exchange fluid circuits both include a liquid collection vessel for collecting condensed heat exchange fluid;
e. the first endless heat exchange fluid circuit extends through a first supplementary heat exchanger for re-vaporising condensed first heat exchange fluid;
f. the second endless heat exchange fluid circuit extends through a second supplementary heat exchanger for re-vaporising condensed second heat exchange fluid; and
g. the apparatus also comprises means for controlling the flow rate of the first heat exchange fluid through the first main heat exchanger and the flow rate of the second heat exchange fluid through the second main heat exchanger.

The apparatus according to the invention may also include in the first endless heat exchange fluid circuit a turbo-expander intermediate the first supplementary heat exchanger and the first main heat exchanger. The turbo-expander may be operatively associated with power generation means, thereby making possible the recovery of power.

The employment of different condensing pressures in the first and second heat exchange fluid circuits makes it possible to keep down the surface area of the first and second main heat exchangers without undue loss of thermodynamic efficiency. Preferably, the temperature difference between the temperature of the first heat exchange fluid at its inlet to the first main heat exchanger and the temperature of the natural gas at its exit from the first main heat exchanger is greater than the temperature difference between the temperature of the second heat exchange fluid at its inlet to the second main heat exchanger and the temperature of the natural gas at its exit from the second main heat exchanger.

In the method and apparatus according to the invention each of the main and supplementary heat exchangers may comprise a single body or core or a plurality of bodies or cores. If plural, the heat exchange bodies or cores may be arranged in series or in parallel.

The apparatus according to the invention preferably additionally comprises at least one liquid pump for taking liquid heat exchange fluid from the collection vessel and for circulating it through the first and second endless heat exchange circuits.

The liquid heat exchange fluid in the first and second heat exchange circuits is preferably collected in a common collection vessel which is shared by the first and second heat exchange fluid circuits. Accordingly, the first heat exchange fluid is preferably the same as the second heat exchange fluid.

Alternatively, each circuit may have its own collection vessel and its own liquid pump. In this case, the first heat exchange fluid may be different from the second heat exchange fluid.

The flow rates of the first and second heat exchange fluids through the first and second main heat exchangers, respectively, are preferably varied in accordance with any changes in the thermal load thereupon. Accordingly, the control means preferably includes a first valve means adapted to be operated so as to vary the flow rate of the first heat exchange fluid through the first main heat exchanger in accordance with any variation in the thermal load thereupon. Likewise, the control means preferably includes a second valve means which is also preferably adapted to be operated so as to vary the flow rate of the second heat exchange fluid through the second main heat exchanger in accordance with any variations in the thermal load thereupon. If the first endless heat exchange circuit includes a turbo-expander, the flow rate may be controlled by the inlet guide vanes of the turbo-expander.

In examples of the method and apparatus according to the invention in which the first endless heat exchanger circuit includes a turbo-expander, this circuit preferably additionally includes a liquid pump with a variable frequency drive operable to vary the pressure ratio across the turbo-expander. This enables the circuit to cater for different re-vaporising and condensing temperatures.

The first valve means is preferably positioned in the first endless heat exchange fluid circuit intermediate the liquid pump and the inlet of the first heat exchange fluid to the first supplementary heat exchanger. The second valve means is preferably positioned in the second endless heat exchange fluid circuit immediate the outlet for the second heat exchange fluid from the second main heat exchanger and the common collection vessel.

The apparatus according to the invention preferably also includes a conduit for recirculating condensed heat exchange fluid to the common collection vessel and a third valve means in the conduit for opening (or increasing the flow rate through) the said conduit in the event of the thermal load on the apparatus falling below a chosen minimum.

Preferably the pressure in the ullage space of the common collection vessel is essentially the condensing pressure of the first endless circuit exchange fluid.

The first and second liquid heat exchange fluids may be heated in the first and second supplementary heat exchangers by any convenient medium, but the temperature of this medium influences the choice of the heat exchange fluid. Sea water is typically a convenient medium to use on board a seagoing vessel, but other media such as fresh water, engine cooling water or a mixture of water and ethylene glycol can be used instead. In general, if the said medium is supplied at approximately ambient temperature, propane is a preferred choice for both the first and second heat exchange fluids. Propane is readily available commercially and has thermodynamic properties that enable the condensing temperatures in the first and second main heat exchangers to be selected to be above minus 40° C. but below plus 15° C. Other heat exchange fluid can be used instead of or in a mixture with propane. Such alternative or additional heat exchange fluids contain ethane, butane, other hydrocarbons and fluorocarbon refrigerants, particularly R134(a). The selected heat exchange fluid preferably has a positive equilibrium pressure down to minus 30° C. or minus 40° C. If the temperature of the seawater (or alternative medium) is particularly low, the first and second heat exchange fluids may both be composed of the same mixture of propane and ethane. If, on the other hand, such temperature is particularly high, the first and second heat exchange fluids may both be composed of the same mixture of propane and butane.

The first and second heat exchange fluids may be fully vaporised and, if desired, superheated in the first and second supplementary heat exchangers. If desired, there may be a superheating section separate from the vaporising section. Both such sections may be provided in different bodies. Alternatively, they may be partially vaporised in the first and second supplementary heat exchangers, in which case both the first and second heat exchange circuits may include a phase separator to disengage unvaporised heat exchange fluid from its vapour. The resulting liquid may be returned to the collection vessel associated with the heat exchange circuit.

In a preferred example of the method according to the invention in which the said flow of the natural gas under pressure is taken from a storage tank and is employed upstream of its passage through the first main heat exchange to condense vapour boiling off from the storage tank. Apparatus for performing the preferred example may comprise a storage tank for the liquefied natural gas, a submerged pump in the storage tank for withdrawing a flow of liquefied natural gas therefrom, a booster pump for further raising the pressure of the liquefied natural gas and for supplying the pressurised liquefied natural gas to the first main heat exchanger, wherein the submerged pump communicates with the booster pump via a suction vessel so as to maintain an adequate net positive suction head for the booster pump, wherein the suction vessel also communicates with a compressor for withdrawing boiled-off natural gas from the storage tank, and wherein the suction vessel contains liquid-vapour contact surfaces for bringing the boiled off natural gas into intimate contact with the liquefied natural gas so as to effect condensation of the boiled-off natural gas.

The method and apparatus according to the invention will now be described by way of example with reference to the accompanying drawings, in which:

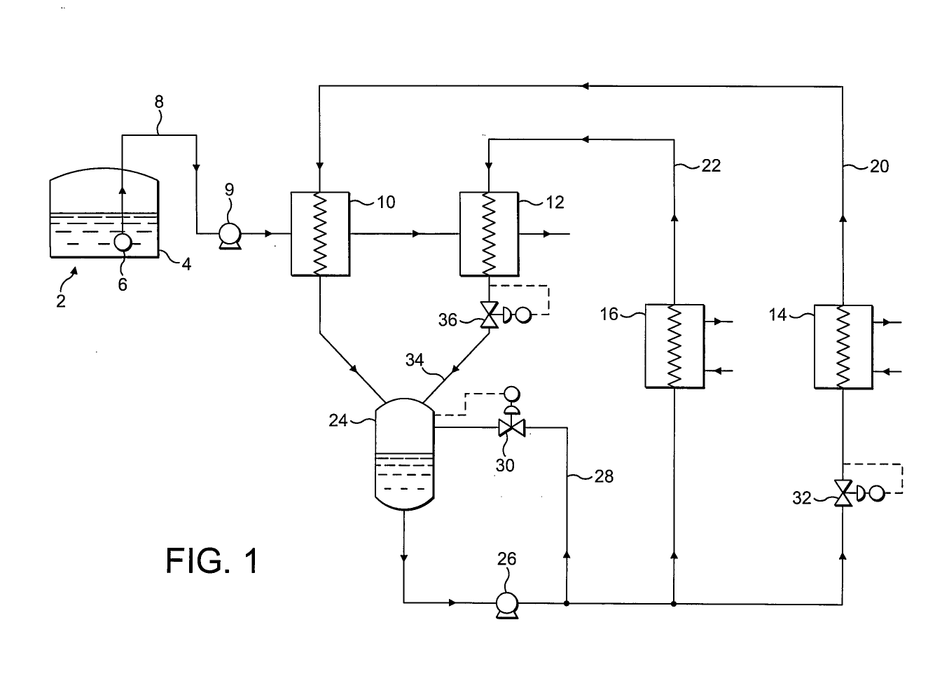

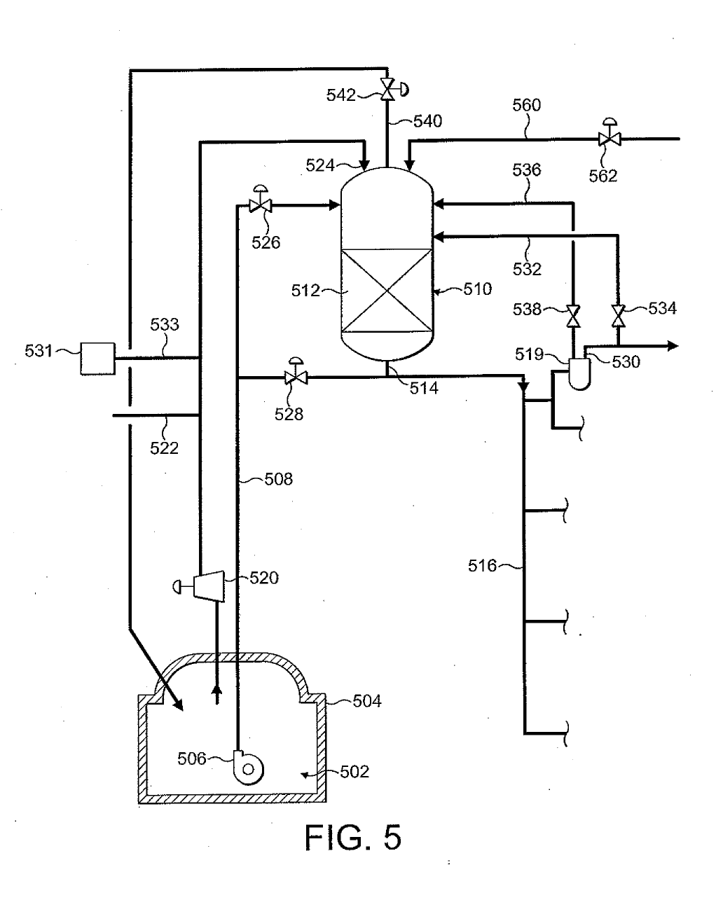

FIGS. 1 to 4 are general schematic flow diagrams of different forms of LNG vaporisation apparatus and FIG. 5 is showing the upstream part of the apparatus;

Referring to FIG. 1, an LNG facility 2 typically comprises at least one thermally-insulated storage tank 4 having a submerged LNG pump 6. The outlet of the pump 6 communicates with a conduit 8 having disposed therealong, outside the facility 2, a second LNG pump 9. The outlet of the pump 9 communicates with an apparatus according to the invention for heating the flow of LNG. The facility is typically located aboard a seagoing vessel, which may, for example, be a so-called FSRU (Floating Storage and Regasification Unit). There is from time-to-time a need to deliver natural gas from the facility 2 at elevated pressure and a non-cryogenic temperature, typically a temperature close to ambient temperature. The apparatus as shown in FIG. 1 enables the natural gas to be delivered at a chosen pressure, rate and temperature. This apparatus includes a first main heat exchanger 10, a second main heat exchanger 12, a first supplementary heat exchanger 14 and a second supplementary heat exchanger 16. The first and second main heat exchangers 10 and 12 are both adapted to be heated by a common condensing heat exchange fluid flowing countercurrently to the natural gas.

There is a first endless heat exchange fluid circuit 20 that causes the heat exchange fluid to flow through the first main heat exchanger 10 and the first supplementary heat exchanger 14, and a second such circuit 22 which causes the heat exchange fluid to flow through the second main heat exchanger 12 and the second supplementary heat exchanger 16. The circuits 20 and 22 have in common a liquid heat exchange fluid collection vessel 24 and a pump 26 for raising the pressure to which the liquid heat exchange fluid is subjected. It is, however, possible for each circuit to have its own dedicated collection vessel. The first endless heat exchange fluid circuit 20 extends from a liquid outlet from the first main heat exchanger 10 to the liquid collection vessel 24 and includes the pump 26. Downstream of the pump 26 the first heat exchange fluid circuit 20 extends through the first supplementary heat exchanger 14 in which the liquid heat exchange fluid is reconverted to a vapour. The heat exchange fluid circuit 20 is completed by a conduit placing the outlet for vaporised heat exchange fluid from the first supplementary heat exchanger 14 in communication with an inlet for vaporised heat exchange fluid to the main heat exchanger 10. If desired, both the heat exchange circuits may communicate or be able to be placed in communication with a source of back up heat exchange fluid to enable any loss of heat exchange fluid from the circuits to be made up.

Sufficient flow of the heat exchange fluid through the first main heat exchanger 10 is provided so as to vaporise all the liquefied natural gas flowing there through and to superheat it to a chosen temperature. It is to be appreciated, however, that the pump 8 may typically raise the pressure of the liquefied natural gas to above its critical pressure, say to about 100 bar, in which case, the natural gas enters the first main heat exchanger 10 is a supercritical fluid, so strictly speaking, is not vaporised. Whether or not the liquefied natural gas is presented to the first main heat exchanger 10 as a supercritical fluid, the apparatus shown in FIG. 1 is operated so as to ensure that the temperature at which it leaves the first main heat exchanger 10 is in a chosen temperature range, somewhat below 0° C.

The second heat exchange circuit 22 is operated so as to raise the temperature of the natural gas further to a chosen delivery value. In the second heat exchange fluid circuit 22, some liquid heat exchange fluid is diverted from the first heat exchange fluid circuit 20 from a region downstream of the pump 26 and flows through the second supplementary heat exchanger 16 in which it is vaporised. The resulting vapour flows to an inlet for heat exchange fluid to the second main heat exchanger 12. This heat exchange fluid is condensed in the second main heat exchanger 12 by heat exchange with the natural gas, the natural gas thereby being heated to the desired temperature. The so condensed heat exchange fluid passes from the second main heat exchanger to the common collection vessel 24 via a pipe or conduit 34.

The necessary heat for the first and second supplementary heat exchangers 14 and 16 may be provided by any convenient supplementary heat exchange medium.

The liquid vessel 24 is provided with a recycle conduit 28. One end of the conduit 28 terminates in a common region of the heat exchange circuits 20 and 22 which is downstream of the outlet of the pump 26 but upstream of where the second heat exchange circuit 22 branches from the first heat exchange circuit 20. The other end of the conduit 28 terminates within the liquid collection vessel 24. A valve 30 is disposed within the conduit 28. The valve 30, when open, enables condensed heat exchange fluid to be withdrawn from the heat exchange circuits 20 and 22. Such withdrawal may be carried out if the thermal load on the main heat exchangers 10 and 12 falls below a chosen level.

The rate of flow of heat exchange fluid through the main heat exchangers 10 and 12 are controlled by a first valve 32 and a second valve 36, respectively. The first valve 32 is positioned intermediate the outlet of the pump 26 and the inlet for the heat exchange fluid to the first supplementary heat exchanger 14. The second valve 36 is positioned in the conduit 34. The valves 32 and 36 are operated so as to vary the flow rates of the heat exchange fluid through the first and second main heat exchangers 10 and 12, respectively with any changes in the thermal load thereupon.

In operation, the heat exchange fluid effects indirect heat exchange between the supplementary heat exchange medium and the liquefied natural gas. On board a ship or FSRU, seawater is a particularly convenient supplementary heat exchange medium. It can, for example, be taken from the surroundings of the ship or FSRU. Other media such as fresh water, engine cooling water, or a mixture of water and ethylene glycol can be used instead. The supplementary heat exchange medium may flow in open or closed circuit. If in closed circuit, the temperature of the supplementary heat exchange medium may be readily controlled by means of an additional heat source, for example, a boiler, and the heat exchange fluid selected in accordance with this temperature. The preferred heat exchange fluid is propane. Propane is readily available commercially and has thermodynamic properties that enable the condensing temperatures in the first and second main heat exchangers 10 and 12 to be above minus 40° C. but below +15° C. If the supplementary heat exchange medium, for example, sea water, flows in open circuit, however, its temperature may vary throughout the year and with the geographical location of the ship or FSRU. The incoming temperature of the sea water may accordingly vary between, say, 10 and 27° C. If desired, the propane may be mixed with ethane for lower supplementary heat exchange medium temperatures and with butane for higher temperatures. In general, the choice of the heat exchange fluid needs to be made in light of these factors, bearing in mind that the heat exchange fluid desirably has a positive equilibrium pressure down to minus 30° C. and preferably down to minus 40° C.

In typical operation, the thermal load on the heat exchangers 10 and 12, that is the heat they are required to provide in order to raise the temperature of the LNG from its storage temperature of below minus 150° C. to a chosen supply temperature (for example +5° C.) is likely to vary. The apparatus shown in FIG. 1 is able to meet these variations. The flow of the heat exchange fluid through the first supplementary heat exchanger 14 is typically such as to cool the sea water or other medium by 5 to 7° C. The heat exchange fluid is changed in state from liquid to vapour in the first supplementary heat exchanger 14 and may be slightly superheated. It is this vapour that serves to heat the LNG in the first main heat exchanger 10. The heat exchange fluid condenses again in the first main heat exchanger 10. The operation of the second main heat exchanger 12 is analogous to that of the first main heat exchanger 10. The natural gas is heated in it by indirect heat exchange with condensing heat exchange fluid. The operation of the valves 32 and 36 has the effect of making the condensing pressure in the second main heat exchanger 12 higher than in the first main heat exchanger 10. The difference in the condensing pressures is equal to the differential pressure across the pump 26 minus the pressure drops in the relevant piping and heat exchangers. Further, the condensing pressure in the first main heat exchanger is equal to the condensing pressure in the ullage space of the common collection vessel. This pressure is not fixed but tends to float as the heat exchange circuits adjust to a change in the thermal load. For higher loads, the condensing pressure in the first main heat exchanger 10 is lower, these pressure changes being brought about by adjustment of the valve 32 in response to changes in the thermal load upon the heat exchanger 10. If desired, the adjustment of the valve 32 may be effected automatically in response to a parameter which is a function of the changes in thermal load. The valve 36 may be similarly adjusted and because the condensing pressure in the first main heat exchanger 10 floats, so does the condensing pressure in the second main heat exchanger 12.

Because the condensing pressure in the second main heat exchanger 12 is greater than the condensing pressure in the first main heat exchanger 10, the sizes of the two heat exchangers can readily be kept down without undue loss of thermodynamic efficiency even at low sea water (or other supplementary exchange medium) temperatures. In general, the first main heat exchanger 10 is called upon to meet a larger thermal load than the second main heat exchanger. It is preferred that the difference in temperature between the heat exchange fluid entering the first main heat exchanger 10 and the natural gas exiting it is greater than the difference in temperature between the heat exchange fluid entering the second main heat exchanger 12 and the natural gas exiting from it.

It can be understood that the pressure difference across the pump 26 is a significant factor in determining the difference in condensing pressure and hence condensing temperature between the two main heat exchangers 10 and 12. Typically, the pump 26 has a constant frequency drive and therefore the differential pressure cannot be altered. This is not a disadvantage as the apparatus shown in FIG. 1 can generally cope with normal changes in thermal load that are encountered. If the thermal load falls too much causing the control valves 32 and 36 to throttle the flow too much, the setting of the valve 30 is able automatically to maintain the minimum flow through the pump 26 necessary for it be run. If the thermal load rises too much, then a valve (not shown) in the LNG pipeline can be adjusted to reduce the LNG flow. At lower sea water inlet temperatures however (say in the order of 10° C.), it may be advantageous to use a variable frequency pump 26 and operate it at a slightly increased pressure differential to reduce the condensing temperature in the first main heat exchanger 10 at higher thermal loads.

In a typical example, the first main heat exchanger 10 raises the temperature of the LNG to minus 40 to minus 20° C. so that it vaporises (unless at a supercritical pressure) and the second main heat exchanger 12 further raises its temperature to 0 to 5° C. The first main heat exchanger 10 may typically meet 80% of the thermal load and the second main heat exchanger 12 the remaining 20%. In this example, the heat exchange fluid is propane, and the supplementary heat exchange medium is seawater.

The apparatus shown in FIG. 1 is essentially self-adjusting to changes in the LNG vaporisation load placed upon it. If the LNG flow decreases, there will be a lower rate of condensation of propane in the heat exchangers 10 and 12 and the propane pressure will increase in the supplementary heat exchangers 14 and 16 and the common collection vessel. This increase in pressure has a compensatory effect on the propane vaporisation rate by decreasing the temperature difference between the supplementary heat exchange medium and the vaporising propane in the heat exchangers 14 and 16. The heat exchange circuits 20 or 22 are able to adjust to keep the temperature of the vaporised propane no more than a few degrees Celsius above its boiling temperature. Similarly, if the LNG flow increases, there will be a higher rate of condensation of propane in the heat exchangers 10 and 12 and the propane pressure will fall in the supplementary heat exchangers 14 and 16 and the common collection vessel 24. This decrease in pressure has a compensatory effect on the propane vaporisation rate by increasing the temperature difference between the supplementary heat exchange medium and the vaporising propane in the heat exchangers 14 and 16. The heat exchange circuits 20 and 22 are able to adjust to keep the temperature of the vaporised propane no more than a few degrees Celsius above its boiling temperature.

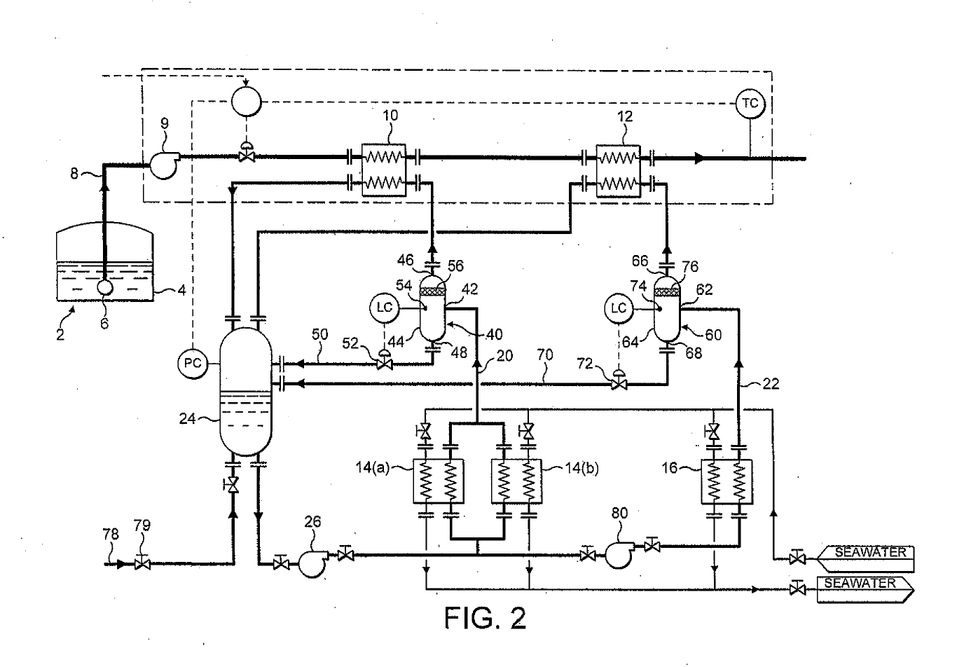

The apparatus shown in FIG. 2 enables superheating of the propane (or other heat exchange fluid in the supplementary heat exchangers 14 and 16 to be avoided. Now the heat exchange circuits 20 and 22 both include phase separators, and the supplementary heat exchangers 14 and 16 effect only partial vaporisation of the propane or other heat exchange fluid.

A first phase separator 40 is provided in the first heat exchange circuit 20 intermediate the propane exit and of the first supplementary heat exchanger 14 and the propane inlet end of the first main heat exchanger 10. If desired, as shown in FIG. 2, the first supplementary heat exchanger 14 may be split and comprise two parallel heat exchange units 14(a) and 14(b).

The first phase separator 40 has an inlet 42 for a liquid-vapour propane mixture to a vessel 44, in which the liquid phase collects.

The phase separator vessel 44 has a first outlet 46 at its top for vapour communicating with the propane inlet to the first main heat exchanger 10, and a second outlet 48 at its bottom for liquid propane communicating with the common collection vessel 24. A flow control valve 52 is located at the conduit 50 and is operatively associated with a level detector 54 in the vessel 44 such that a constant liquid propane level can be maintained thereon. A demister 56 is located in the vessel 44 in order to disengage droplets of liquid from the vapour flowing to the first main heat exchanger 10.

A second phase separator 60 is provided in the second heat exchange circuit 22 intermediate the propane exit end of the second supplementary heat exchanger 16 and the propane exit end of the second main heat exchanger 12. The second phase separator 60 has an inlet 62 for a liquid-vapour mixture to a vessel 64, a first outlet 66 at its top for vapour communicating with the propane inlet to the second main heat exchanger 12, and a second outlet 68 at its bottom for liquid propane communicating via conduit 70 with the common liquid propane collection vessel 24. A flow control valve 72 is located in the conduit 70 and is operatively associated with a level detector 74 in the vessel 64 such that a constant liquid level can be maintained therein. A demister 76 is located in the vessel 64 in order to disengage droplets of liquid from the vapour flowing to the second main heat exchanger 12.

The heat exchangers 14 and 16 may be split into two or more parallel parts.

In view of the provision of the phase separators 40 and 60, the recycle conduit 28 and the valve 30 are omitted from the apparatus shown in FIG. 2. Operation of the apparatus shown in FIG. 2 is analogous to that shown in FIG. 1, but there is no superheating of the propane in the heat exchangers 14 and 16.

In comparison with the apparatus shown in FIG. 1, the apparatus shown in FIG. 2 has an additional liquid pump 80 to assist in the circulation of the liquid propane. The pumps 26 and 80 are operable to vary, if desired, the pressure difference between the propane in the heat exchange circuits 20 and 22. In operation, the heat exchange circuits 20 and 22 are self-adjusting in a manner analogous to the corresponding circuits in the apparatus shown in FIG. 1. The apparatus may be charged with propane via a conduit 78 having stop valve 79 disposed therein and terminating in the collection vessel 24.

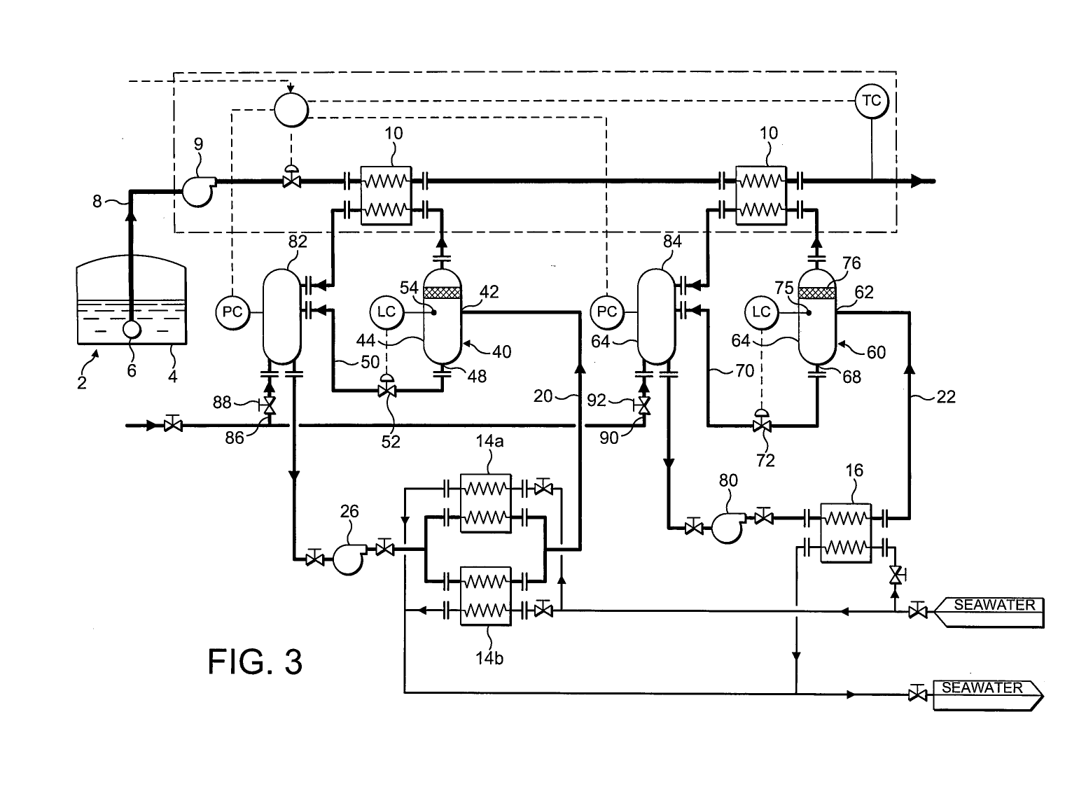

Referring now to FIG. 3 of the drawings, there is shown a variation on the apparatus shown in FIG. 2, in which instead of there being a common collection vessel 24, both the heat exchange circuits 20 and 22 have dedicated liquid propane collection vessels 82 and 84, respectively. Thus the circuits 20 and 22 are separate from each other and each circuit has its own liquid propane supply pipeline 86, having a stop valve 88 disposed therein, terminating in the vessel 82, and the circuit 22 has a liquid propane supply pipeline 90, with a stop valve 92 disposed therein, terminating in the vessel 64.

In operation of the apparatus shown in FIG. 3, the pumps 26 and 80 simply create the necessary circulation of liquid propane and compensate for pressure drops in the apparatus. In other respects, operation of the apparatus shown in FIG. 3 is analogous to that shown in FIG. 2.

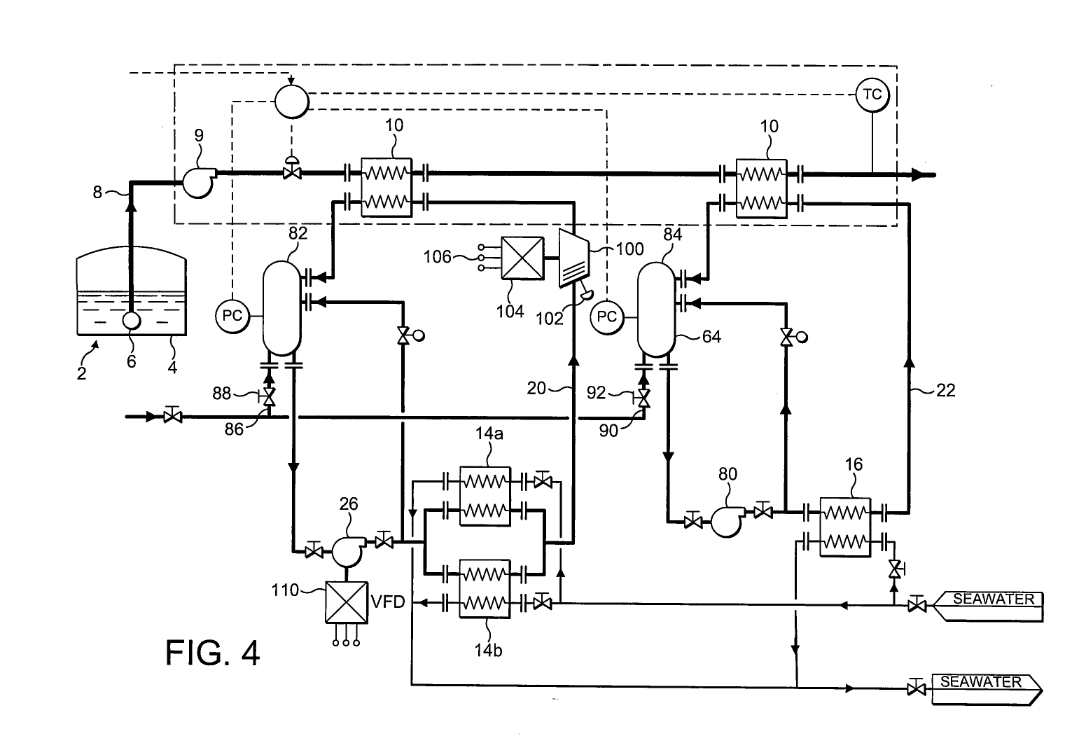

Referring now to FIG. 4 of the drawings, there is shown a variant of the apparatus shown in FIG. 1 in which instead of there being a common collection vessel 24, both the heat exchange circuits 20 and 22 have dedicated liquid collection vessels 82 and 84, respectively. Thus the circuits 20 and 22 have dedicated liquid collection vessels 82 and 84, respectively. Thus the circuits 20 and 22 are separate from each other. The circuit 20 has its own liquid heat exchange fluid supply pipeline 86, having a stop valve 88 disposed therein, terminating in the vessel 82, and the circuit 22 has a liquid heat exchange fluid supply pipeline 90, with a stop valve 92 disposed therein, terminating the vessel 84. The heat exchange fluid in the circuit 20 can be of the same or a different composition from that of the heat exchange fluid in the circuit 22.

The circuit 20 has a turbo-expander 100 intermediate the heat exchange vapour exit from the supplementary heat exchanger 14 and the heat exchanger vapour inlet to the main heat exchanger 10. The turbo-expander 100 is operatively associated in a conventional way with a generator 104 that is connected to an electrical grid 106, thus making possible power recovery from the heat exchanger fluid. The cycle pump 26 is designed correspondingly for a higher differential pressure to suit the turbine design pressure ratio and is equipped with a variable frequency drive 110 to adapt the pressure ratio for different re-vaporising and condensing temperatures.

In operation of the apparatus shown in FIG. 4, the pump 26 creates the necessary pressure differential for the operation of the turbo-expander 100 to generate electrical power in addition to circulating the heat exchange fluid in the circuit 20. The pump 80 circulates the heat exchange fluid in the circuit 22. In addition, both pumps 26 and 80 compensate for pressure drops in the apparatus. In other respects, operation of the apparatus shown in FIG. 4 is analogous to that shown in FIGS. 1 and 3.

Referring now to FIG. 5, there is shown an upstream part of a modified LNG superheating apparatus installed on board ship, in which excess natural gas that is boiled off during a regasification operation is recondensed. The recondensation is effected by contact with subcooled LNG taken from the storage tank or tanks. The condenser is incorporated in suction drum or suction tank which provides a sufficient net positive suction head (NPSH) to the booster pump or pumps which raise the pressure of the LNG to a suitable level for passage through the first and second main heat exchangers of the apparatus according to the invention.

Referring to FIG. 5 an LNG facility 502 typically comprises at least one and usually several thermally-insulated storage tanks 504, each having a submerged LNG pump 506. (Only one insulated storage tank 504 with its associated submerged LNG pump 506 is shown in FIG. 5). The outlet of the pump 506 communicates with the conduit 508. The conduit 508 terminates in a vessel 510 which, as shall be described below, provides a net positive suction head for downstream booster pumps and which serves as a condenser for natural gas boiling off from the storage tank 504. There is a natural rate of boil off from the LNG stored in the tank 504 as a result of the absorption of heat from its surrounding environment. The natural rate of boil off may be enhanced during the operation to supply natural gas from the tank 504 as a result of the power expended by the LNG pump 506. In operation, the boiled off natural gas is withdrawn from the tank 504 by a compressor 520. A part of the compressed boiled-off gas is typically supplied via a conduit 522 to the engines of the revaporisation ship or FSRU on board which the storage facility 502 is located. The remainder of the boiled-off natural gas passes to an inlet 524 to the vessel 510. The flow of LNG into the vessel 510 from the conduit 508 is predetermined so as to ensure that all the boiled off natural gas entering the vessel 510 is condensed therein by contact with the LNG on the surfaces of a packing 512 or another liquid-vapour contact medium located within the vessel 510. It is to be understood that the LNG enters the vessel 510 in subcooled state by virtue of the operation of the pump 506 to raise its pressure. Accordingly, it is able to effect the necessary condensation of the boiled off natural gas. The resulting LNG passes out of the vessel 510 through an outlet 514 to a distribution line 516. LNG which is not required for the purposes of condensation in the vessel 510 may by-pass that vessel and be reunited in the distribution line 516 with the LNG from the vessel 510. A control valve 526 is located in the conduit 508 so as to control the flow of subcooled LNG to the vessel 510. The flow of LNG that by-passes the vessel 510 may be controlled by a further flow control valve 528. Any excess boiled-off natural gas may be vented via a conduit 533 to a gas combustion unit 531.

The distribution line 516 communicates with a plurality of booster pumps 519. For ease of illustration, only one such pump is shown in FIG. 5, but in a typical installation several such pumps may be provided, single pump or pairs of pumps supplying separate arrays of first and second main heat exchangers for vaporising and superheating LNG in accordance with the invention. For ease of illustration, the heat exchangers are not shown in FIG. 5, but any one of the arrangements shown in FIGS. 1 to 4 may be employed.

Each pump 519 has an outlet 530 communicating with a vaporisation and superheating apparatus (not shown). Each pump 519 may be arranged to supply a variable flow of LNG to the apparatus. Excess LNG may be returned to the vessel 510 through a pipeline 532. A flow control valve 534 may automatically open if the sensed pump flow rate is getting smaller than the required minimum flow rate.

Natural gas vaporising within each pump 519 may also be returned via pipeline 536 to the vessel 510. A vent valve 538 is disposed in the pipeline 536 for this purpose.

The apparatus as shown in FIG. 5 also includes a return pipeline 540 from the top of the vessel 510 to the storage tank 504. The pipeline 540 has a control valve 542 located therein. Valve 542 is normally kept closed. Valve 542 opens automatically in the event of a low level being detected in the vessel 510. In the event of high level being detected in the vessel 510, the control valve 562 in pipeline 560 connected to higher pressure gas source opens automatically.

The apparatus shown in FIG. 5 is thus able to provide the necessary flow of liquefied natural gas under pressure for downstream vaporisation and superheating by the method according to the invention.

1. A method of converting liquefied natural gas to a superheated fluid, comprising:
a. passing a flow of the natural gas under pressure through a first main heat exchanger and a second main heat exchanger in series with one another;
b. heating the flow of the natural gas in the first main heat exchanger by heat exchange with a first heat exchange fluid flowing in a first endless circuit at a first pressure, the first heat exchange fluid undergoing a change of state from vapour to liquid in said first main heat exchanger;
c. further heating the flow of the natural gas in the second main heat exchanger by heat exchange with a second heat exchange fluid flowing in a second endless circuit at a second pressure, the second heat exchange fluid being of the same composition as the first heat exchange fluid and undergoing a change of state from vapour to liquid in said second main heat exchanger;
d. collecting liquid first heat exchange fluid from the first main heat exchanger and liquid second heat exchange fluid from the second main heat exchanger;
e. re-vaporising in the first endless heat exchange fluid circuit a flow of the liquefied first heat exchange fluid in a first supplementary heat exchanger and supplying the resulting vapour as the first heat exchange fluid to the first main heat exchanger;
f. re-vaporising a flow of the second liquid heat exchange fluid in a second supplementary heat exchanger in the second endless heat exchange circuit and supplying the resulting vapour as the second heat exchange fluid to the second main heat exchanger;
and wherein
g. the condensing pressure of the first heat exchange fluid in the first main heat exchanger is less than the condensing pressure of the second heat exchange fluid in the second main heat exchanger.

2. A method according to claim 1, wherein the liquid heat exchange fluid from the first and second heat exchangers is collected in a common collection vessel.

3-5. (canceled)

6. A method according to claim 1, wherein the first and second heat exchange fluids are fully vaporised in the first and second supplementary heat exchangers, respectively.

7. A method according to claim 6, wherein the first and second heat exchange fluids are superheated in the first and second supplementary heat exchangers, respectively.

8. A method according to claim 7, wherein the first and second heat exchange fluids are superheated downstream of the supplementary heat exchangers.

9. A method according to claim 1, wherein the first and second heat exchange fluids are partially vaporised in the first and second supplementary heat exchangers, respectively, and additionally including disengaging unvaporized heat exchange fluid from the vaporized heat exchange fluid.

10-15. (canceled)

16. A method according to claim 1, wherein the said resulting vapour in step (e) is turbo-expanded intermediate the first supplementary heat exchanger and the main heat exchanger.

17. (canceled)

18. Apparatus for converting liquefied natural gas to a superheated fluid, comprising:
a. a first main heat exchanger and a second main heat exchanger in series with one another arranged for the heating of the liquefied natural gas in heat exchange with a condensing first heat exchange fluid and a condensing second heat exchange fluid, respectively;
b. a first endless lower condensing pressure heat exchange fluid circuit extending through the first main heat exchanger;
c. a second endless higher condensing pressure heat exchange fluid circuit extending through the second main heat exchanger, wherein
d. the first and second endless heat exchange fluid circuits both include a liquid collection vessel for collecting condensed heat exchange fluid;
e. the first endless heat exchange fluid circuit extends through a first supplementary heat exchanger for re-vaporising condensed first heat exchange fluid;
f. the second endless heat exchange fluid circuit extends through a second supplementary heat exchanger for re-vaporising condensed second heat exchange fluid; and
g. the apparatus also comprises means for controlling the flow rate of the first heat exchange fluid through the first main heat exchanger and the flow rate of the second heat exchange fluid through the second main heat exchanger.

19. Apparatus according to claim 18, wherein the first and second endless heat exchange circuits have a common liquid collection vessel.

20. (canceled)

21. Apparatus according to claim 18, wherein said control means comprises a first valve means which is adapted to be operated so as to vary the flow rate of the first heat exchange fluid through the first main heat exchanger in accordance with any variations in the thermal load thereupon.

22. (canceled)

23. Apparatus according to claim 18, wherein the control means comprises a second valve means for controlling the flow rate through the second main heat exchanger.

24-25. (canceled)

26. Apparatus according to claim 21, further comprising a conduit for recirculating condensed heat exchange fluid to the common collection vessel, and a third valve means in the conduit for opening or increasing the flow rate in the said conduit in the event of the thermal load on the apparatus falling below a chosen minimum.

27. Apparatus according to claim 18, wherein both the first and second endless heat exchange circuits comprise a phase separator for disengaging unvaporised heat exchange fluid from vaporised heat exchange fluid.

28. Apparatus according to claim 18, wherein the first endless heat exchange circuit is independent of the second endless heat exchange circuit and comprises a turbo-expander intermediate the first supplementary heat exchanger and the first main heat exchanger.

29-30. (canceled)

31. Apparatus according to claim 28, wherein the first endless heat exchange circuit comprises a pump with a variable frequency drive operable to vary the pressure ratio across the turbo-expander.

32. (canceled)

33. Apparatus according to claim 18, further comprising a first pump and a second pump in series, the first pump being common to both heat exchange circuits and the second pump being situated in the second heat exchange circuit.

34. Apparatus according to claim 18, wherein the first heat exchange circuit comprises a first liquid heat exchange fluid collection vessel and a first liquid heat exchange circulation pump, and the second heat exchange circuit comprises a second liquid heat exchange fluid collection vessel and a second liquid heat exchange fluid circulation pump.
